(19) United States
(12) Patent Application Publication
(10) Pub. No.: US 2006/0115648 A1
(43) Pub. Date: Jun. 1, 2006

(54) Nanofibers and process for making the same

(75) Inventor: Ga-Lane Chen, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/200,826

(22) Filed: Aug. 10, 2005

(30) Foreign Application Priority Data
Aug. 11, 2004 (CN) 200410051105.6

(51) Int. Cl. D01D 5/08; D01D 1/04; D01D 10/02; H05B 6/02; B29C 45/76; D01D 5/40; B29C 47/00; B29C 47/88; B29C 71/00; D02G 3/00

(52) U.S. Cl. 428/359; 264/176.1; 264/140; 264/211.12; 264/235; 264/472; 264/40.1; 264/237; 428/364; 977/773

(57) ABSTRACT

The present invention provides nanofibers and a process for making the same. The nanofibers are made from composite materials comprised of at least two of SiC, Si₃N₄, Al₂O₃, BC, BN, AlN, C, TiN, TiC, Y₂O₃, and ZrO₂, such as SiC+C, SiC+Al₂O₃, SiC+AlN, SiC+TiN, SiC+TiC, SiC+Si₃N₄, Si₃N₄+TiN, Si₃N₄+C, Si₃N₄+Al₂O₃, Si₃N₄+AlN, Si₃N₄+TiC, Al₂O₃+C, Al₂O₃+TiN, Al₂O₃+TiC, Al₂O₃+Y₂O₃, Al₂O₃+ZrO₂, BN+Si₃N₄ and BC+Si₃N₄. The process for making nanofibers comprises the following steps: making a precursor material and spinning nanofibers from the precursor material.

### FIELD OF THE INVENTION

The present invention relates to nano-materials, and more specifically, to nanofibers and a process for making nanofibers.

### BACKGROUND

The nanometer (nm) is a unit of length. “Nano” not only indicates the smallness of a material, but also to the characteristic properties derived from the compactness of materials. Such properties include, for example, a lighter weight, a larger surface area, increased surface curvature, improved thermal and electrical conductivities, and so on. Technologies associated with nano chemistry and nano materials are related to material compositions and interface structures, the control of size between 1 and 100 nm, and the transformation of material to acquire special characteristic properties. Such technology is applied to the optoelectronics, electronics, energy-storage and semiconductor fields, in order to develop new materials and key components.

Nano materials are materials which have at least one dimension that is nano sized, and which are constructed on the basis of nano sized units. There are generally three kinds of nano sized units. A “zero-dimension unit” means the three dimensions of the unit are nano sized. Such kind of unit may be a nanoparticle or nanobulk. A “one-dimension unit” means two of the three dimensions of the unit are nano sized. Such kind of unit may be a nanofiber, a nanowire, or a nanotube. A “two-dimension unit” means one of the three dimensions is nano sized. Such kind of unit may be an extra thin film. It is the one-dimension units that will be discussed below.

A carbon nanotube is the most popular one-dimension nano material in international R&D pursuits. The carbon nanotube was first discovered by Japanese researcher Iijima in 1991: see Helical Microtubules of Graphite Carbon, S Iijima, Nature, vol. 354, p. 56 (1991). A good survey and reference is found in Kaili Jiang, Quanqing Li, and Shoushan Fan, Spinning Continuous Carbon Nanotube Yarns, Nature, vol. 419, p. 801 (2002). The creation of continuous yarns made out of carbon nanotubes are widely considered to enable macroscopic nanotube devices and structures to be constructed.

Carbon nanotubes are by no means the only one-dimension nano material of note. There are other good nano materials being studied by many scientists and engineers. For example, China patent 01127650, issued on Dec. 26, 2001 provides a method of fabricating SiC nanofibers by Chemical Vapor Decomposition. However, the longest nanofiber obtainable is only about 5 micrometers.

China patent 02125215, issued on Feb. 12, 2003, provides a method of fabricating ZnO. China patent 02138228, issued on Mar. 12, 2003, provides a method of fabricating AlN.

None of the above-referenced nanofiber fabrication methods can produce long nanofibers. Further, the nanofibers are made from one uniform composition. This limits the potential applications of the methods. What are needed, therefore, are nanofibers and a process for making nanofibers, in which the nanofibers are relatively longer and made of composite materials.

### SUMMARY

One embodiment of the present invention provides nanofibers. The nanofibers are made of the composite materials and longer than traditional nanofibers. The composite materials are comprised of at least two of SiC, Si₃N₄, Al₂O₃, BC, BN, AlN, C, TiN, TiC, Y₂O₃ and ZrO₂, such as SiC+C, SiC+Al₂O₃, SiC+AlN, SiC+TiN, SiC+TiC, SiC+Si₃N₄, Si₃N₄+TiN, Si₃N₄+C, Si₃N₄+Al₂O₃, Si₃N₄+AlN, Si₃N₄+TiC, Al₂O₃+C, Al₂O₃+TiN, Al₂O₃+TiC, Al₂O₃+Y₂O₃, Al₂O₃+ZrO₂, BN+Si₃N₄ and BC+Si₃N₄.

Another embodiment of the present invention provides a process for making the above-described nanofibers. The process comprises: “making a precursor” and “spinning nanofibers.” The steps of “making a precursor” comprise: offering at least two kinds of materials; mixing and stirring; grinding; and sintering. The steps of “spinning nanofibers” comprise: melting and extrusion; annealing; solidifying; and winding.

A main advantage of the embodiments are the length of the nanofibers is more than several tens of meters. The fracture toughness and bending strength are enhanced because of the composite materials. For example, adding SiC into the matrix of TiC, according to the material test, the fracture toughness is raised to 10 MPa.m^{1/2} from 3 MPa.m^{1/2}, the bending strength is between 900 MPa and 1800 MPa and the highest working temperature is 1600° C.

Other advantages and novel features of preferred embodiments of the invention will be drawn from the following detailed description with reference to the attached drawings, in which:

### BRIEF DESCRIPTION OF THE DRAWINGS

FIG. 1 is a flowchart of a process for making a nanofiber in accordance with a preferred embodiment of the present invention;

FIG. 2 is a flowchart of steps of “making a precursor” according to the flowchart of FIG. 1; and

FIG. 3 is a flowchart of steps of “spinning nanofibers” according to the flowchart of the FIG. 1.

### DETAILED DESCRIPTION OF PREFERRED EMBODIMENTS

Hereinafter, preferred embodiments of the present invention will be described. However, the scope of the present invention is not to be taken as limited to the described embodiments.

A first preferred embodiment of the invention is nanofibers, which are made of composite materials as follows. The composite materials comprise any two of SiC, Si₃N₄, Al₂O₃, BC, BN, AlN, C, TiN, TiC, Y₂O₃ and ZrO₂, selected from SiC+C, SiC+Al₂O₃, SiC+AlN, SiC+TiN, SiC+TiC, SiC+Si₃N₄, Si₃N₄+TiN, Si₃N₄+C, Si₃N₄+Al₂O₃, Si₃N₄+AlN, Si₃N₄+TiC, Al₂O₃+C, Al₂O₃+TiN, Al₂O₃+TiC, Al₂O₃+Y₂O₃, Al₂O₃+ZrO₂, BN+Si₃N₄, and BC+Si₃N₄. The composition ratio of each of the two materials is anywhere in the range from 0%<composition ratio<100%. The preferred choices are SiC+Si₃N₄, SiC+Al₂O₃, and Si₃N₄+Al₂O₃.

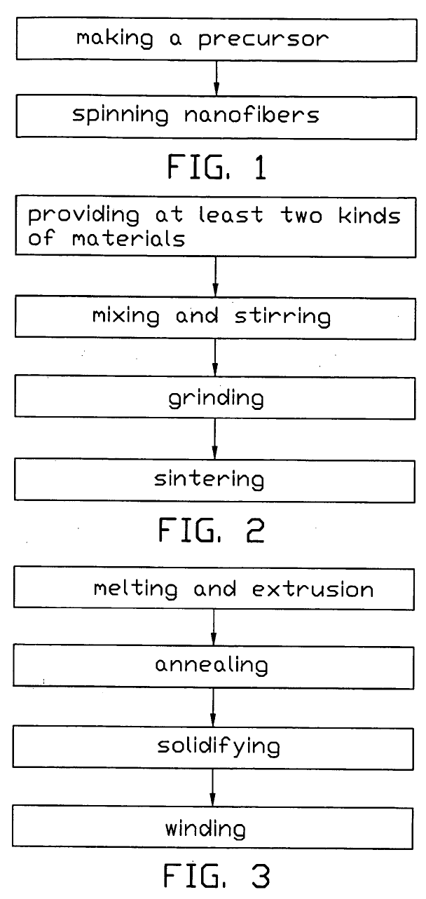

Referring to FIG. 1, a preferred process for making the nanofibers comprises: “making a precursor” and “spinning nanofibers.” Referring to FIG. 2, “making a precursor” comprises four steps: providing at least two kinds of materials; mixing and stirring the materials; grinding the materials; and sintering the materials.

For example, a SiC+C precursor uses SiC as the matrix material, and adds C in an appropriate amount. Alternatively, a SiC+C precursor uses C as the matrix material, and adds SiC in an appropriate amount. After the materials are chosen, they are put into a stirring machine and stirred and mixed with each other. For enhancing bonding abilities, some binders are generally added in. The binders may, for example, be any one or more of epoxy resin, boron poly-amide, graphite polyamide, boron-coated boron aluminum, coated boron titanium and boron graphite epoxy hybrid. After the materials are thoroughly mixed, they are ground to obtain a finer mixture of materials. The mixture of materials is then dried and sintered, to obtain a precursor material.

Referring to FIG. 3, “spinning nanofibers” comprises four steps: melting and extrusion; annealing; solidifying; and winding. The precursor is put into a high-frequency induction furnace, in which the precursor becomes melted material. The melted material is extruded through a tiny hole of the furnace, such that the melted material can be shaped as nanofibers. A diameter measure device is employed for measuring and controlling the diameter of the nanofibers, and an optical sensor is employed for controlling the nanofibers to extruded along a straight path. Then the nanofibers are annealed for enhancing their bending strength and fracture toughness. After annealing, the nanofibers are solidified by a cooling apparatus, such as liquid helium cooling tubes. Finally, the nanofibers are wound around a spool to form a roll of nanofibers.

A second preferred embodiment of the invention is nanofibers, which are made of composite materials as follows. The composite materials are comprised of any three of SiC, Si₃N₄, Al₂O₃, BC, BN, AlN, C, TiN, TiC, Y₂O₃ and ZrO₂, selected from SiC+Si₃N₄+Al₂O₃, SiC+AlN+Si₃N₄, Al₂O₃+TiN+TiC, and Al₂O₃+Y₂O₃+ZrO₂. The preferred choice is SiC+Si₃N₄+Al₂O₃. The composition ratio of each of the three materials is anywhere in the range from 0%<composition ratio<100%. The process of making the nanofibers is essentially the same as that described above in relation to the first preferred embodiment.

Material test data of the above-described nanofibers is shown in the table below:

| | Bending | Fracture | Working |
|---|---|---|---|
| Composite Material | Strength | Toughness | Temperature |
| (additive/matrix) | (MPa) | (MPa · m^{1/2}) | (° C.) |
| SiC/TiC | 900˜1800 | 6.2˜10.0 | ˜1600 |
| TiN/Si₃N₄ | 800˜1750 | 9.8˜16.0 | ˜1500 |
| SiC/Si₃N₄ | 850˜1550 | 4.5˜7.5 | 1200˜1400 |
| SiC/Al₂O₃ | 350˜1520 | 3.5˜4.8 | 800˜1200 |
| Si₃N₄/Al₂O3 | 350˜650 | 3.5˜4.7 | 800˜1300 |
| SiC/Si₃N₄/Al₂O₃ | ˜750 | ˜2.5 | ˜1300 |

The fracture toughness and bending strength are enhanced because the materials are composite materials. For example, when SiC is added into a matrix of TiC, the fracture toughness is raised to 10 MPa.m^{1/2} from 3 MPa.m^{1/2}, the bending strength is between 900 MPa and 1800 MPa, and the highest working temperature is 1600° C. Because the nanofibers have high fracture toughness, they can be spun to lengths of more than several tens of meters.

Although only preferred embodiments have been described in detail above, it will be apparent to those skilled in the art that various modifications are possible without departing from the inventive concepts herein. Therefore the invention is not limited to the above-described embodiments, but rather has a scope defined by the appended claims and allowable equivalents thereof.

What is claimed is:

1. A nanofiber comprising composite materials, which are comprised of at least two of SiC, Si₃N₄, Al₂O₃, BC, BN, AlN, C, TiN, TiC, Y₂O₃, and ZrO₂.

2. The nanofiber according to claim 1, wherein the composite materials are comprised of two kinds of materials, selected from SiC+C, SiC+Al₂O₃, SiC+AlN, SiC+TiN, SiC+TiC, SiC+Si₃N₄, Si₃N₄+TiN, Si₃N₄+C, Si₃N₄+Al₂O₃, Si₃N₄+AlN, Si₃N₄+TiC, Al₂O₃+C, Al₂O₃+TiN, Al₂O₃+TiC, Al₂O₃+Y₂O₃, Al₂O₃+ZrO₂, BN+Si₃N₄, and BC+Si₃N₄.

3. The nanofibers according to claim 2, wherein the composite materials are selected from the group consisting of SiC+Si₃N₄, SiC+Al₂O₃, and Si₃N₄+Al₂O₃.

4. The nanofiber according to claim 1, wherein the composite materials are comprised of three kinds of materials, and are selected from the group consisting of SiC+Si₃N₄+Al₂O₃, SiC+AlN+Si₃N₄, Al₂O₃+TiN+TiC, and Al₂O₃+Y₂O₃+ZrO₂.

5. The nanofiber according to claim 4, wherein the composite material is SiC+Si₃N₄+Al₂O₃.

6. A process for making nanofibers, comprising the steps of:
making a precursor material; and
spinning nanofibers from the precursor material.

7. The process for making nanofibers according to claim 6, wherein the step of making a precursor material comprises the steps of:
providing at least two kinds of materials;
stirring and mixing the materials;
grinding the mixture; and
sintering the ground mixture.

8. The process for making nanofibers according to claim 7, wherein the step of stirring and mixing includes adding one or more binders to the materials.

9. The process for making nanofibers according to claim 7, further comprising the step of drying the mixture after grinding the mixture.

10. The process for making nanofibers according to claim 6, wherein the step of spinning nanofibers from the precursor material comprises the steps of:
melting and extruding the precursor material to form nanofiber preforms;
annealing the nanofiber preforms;
solidifying the nanofiber performs to form nanofibers; and
winding the nanofibers.

11. The process for making nanofibers according to claim 10, wherein the step of melting uses a high-frequency induction furnace.

12. The process for making nanofibers according to claim 10, wherein in the step of extruding, a diameter measuring device is employed for measuring and controlling the diameter of the nanofiber prefroms.

13. The process for making nanofibers according to claim 10, wherein in the step of extruding, an optical sensor is employed for controlling extrusion of the nanofiber preforms along a straight path.

14. A method for manufacturing nanofibers, comprising the steps of:
making a precursor of nanofibers by mixing up at least two kinds of material; and
extruding said precursor into nanofibers through a nano-scaled hole.

15. The method according to claim 14, further comprising the step of melting said precursor before said extruding step, and solidifying said nanofibers by cooling after said extruding step.

16. The method according to claim 14, further comprising the step of annealing said nanofibers for enhancing mechanical properties thereof after said extruding step.

17. The method according to claim 14, further comprising the step of winding said nanofibers about a stool after said extruding step.

18. The method according to claim 14, further comprising the step of sintering a mixture of said at least two kinds of material to form said precursor.

19. The method according to claim 14, wherein said at least two kinds of material are selected from the group of SiC, Si₃N₄, Al₂O₃, BC, BN, AlN, C, TiN, TiC, Y₂O₃, and ZrO₂.
